(19) United States
(12) Patent Application Publication
(10) Pub. No.: US 2007/0224114 A1
(43) Pub. Date: Sep. 27, 2007

(54) Process for producing mesoporous body

(75) Inventors: Hiroaki Yotou, Kariya-city (JP); Miho Ito, Hoi-gun (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/728,595

(22) Filed: Mar. 26, 2007

(30) Foreign Application Priority Data
Mar. 27, 2006 (JP) 2006-085215
Oct. 20, 2006 (JP) 2006-286434

(51) Int. Cl. C01B 39/00; C01B 33/26

(52) U.S. Cl. 423/700; 423/327.1

(57) ABSTRACT

A method for producing a mesoporous body, which comprises preparing an aqueous solution containing a template component (20) serving as a mold of pores of the mesoporous body, dissolving a raw material of the mesoporous body in the aqueous solution to obtain a precipitate, and drying and firing the precipitate, wherein
the aqueous solution to be used contains, in addition to the template component (20), an organic solvent having an affinity for a hydrophobic moiety of the template component (20).

### TECHNICAL FIELD

The present invention relates to a method for producing a mesoporous body and, for example, relates to a catalyst structure used for an exhaust gas purification system for automobiles, a fuel cell and an environment purification system, and a structure used for an absorbent, a magnetic material, an electrode material, an optoelectronics device and a biological/chemical sensor.

### BACKGROUND ART

A mesoporous body is scientifically defined as an article with pores of 5 nm or more and less than 50 nm in diameter. It has regularly aligned pores and a large pore volume per unit weight. Such a mesoporous body is commonly prepared using a metal oxide or the like, by means of a template method using a template consisting of an organic substance as a mold for pores (refer to, for example, Japanese Unexamined Patent Publication No. 2003-531083).

The template method will now be described in detail.

The raw material of a mesoporous body consisting of a metal oxide is dissolved in an aqueous solution of a template component consisting of a surfactant, and heated. By hydrolysis as a result of heating, the raw material of a mesoporous body sticks to the periphery of the template component.

The template component to which the raw material has stuck is agglutinated due to its property as a surfactant so as to form an agglomerate, i.e. a self-organized structure, which is then precipitated. Then, the precipitate is separated, dried and fired to burn the template component in the precipitate. The spaces resulting from the burning of the template component become pores, and thus a mesoporous body is formed.

The above Japanese Unexamined Patent Publication No. 2003-531083 describes a method of increasing the pore size by adding an organic solvent such as trimethylbenzene to an aqueous solution of a template component.

However, according to studies by the present inventors, the method described therein was able to partially increase the pore size of a mesoporous body prepared, but the increase in pore size was not uniform and was accompanied by problems such as the destruction of the regularly aligned structure of the pores in the mesoporous body.

It was found that, to realize a large pore size of 8 nm or more, a regularly aligned mesoporous body such as a hexagonal or cubic structure, could not be prepared in a high yield. Thus, it was difficult by the conventional method to control the pore size of a mesoporous body at a given size.

### SUMMARY OF INVENTIONS

The present invention was accomplished in light of the above problems, and an object thereof is to produce a mesoporous body having increased pores without destruction of the regularly aligned structure of the pores by using a method of producing a mesoporous body using a template.

In order to achieve the above object, the present inventors carried out experiments and studies on the assumption that, in the method of adding an organic solvent in an aqueous solution containing a template component to increase the pore size, an increase in the degree of penetration of the organic solvent into the mold formed by the template component is effective, and thus the present invention has been completed.

More specifically, the present invention is characterized, in the method of preparing an aqueous solution containing a template component serving as a mold for pores in a mesoporous body, by preparation of an aqueous solution containing, in addition to a template component, an organic solvent with an affinity for the template component.

The template component in an aqueous solution is self-organized to form a mold for pores when a precipitate is formed. An organic solvent having an affinity for the template component easily penetrates into the self-organized structure of the template component and can increase the pore size. As a result, a mesoporous body, wherein pores have been efficiently enlarged, can be produced without destruction of the regularly aligned structure of the pores.

As the template component, an amphipathic poly(alkylene oxide) block copolymer can be used. Preferably, the molecular weight of the poly(alkylene oxide) block copolymer is 1,000 or more.

Specifically, one or more block copolymers selected from triblock copolymers, wherein a hydrophilic polyalkylene oxide is bound covalently to each facing terminal of a hydrophobic polyalkylene oxide, and diblock copolymers, wherein a hydrophobic polyalkylene oxide is bound covalently to a terminal of a hydrophilic polyalkylene oxide, can be employed.

Furthermore, polyethylene oxide can be employed as the hydrophilic polyalkylene oxide, and those selected from polypropylene oxide, polybutylene oxide, polyphenylene oxide and a polyhydroxy acid can be employed as the hydrophobic polyalkylene oxide. In addition, when the hydrophobic polyalkylene oxide is a polyhydroxy acid, the hydroxy acid can be those selected from glycolic acid, lactic acid, malic acid, tartaric acid and citric acid.

The organic solvent having an affinity for the template component includes those soluble in the hydrophobic polyalkylene oxide. Specifically, at least one or more compounds selected from cyclic ethers, glycol diethers, benzenes, esters, ketones and alkanes can be used.

Examples of the organic solvent having an affinity for the template component include those soluble in the hydrophilic polyalkylene oxide. Specifically, at least one or more compounds selected from alkylene oxides, alcohols, carboxylic acids and esters can be used.

Preferably, regarding the weight ratio of the template component to the organic solvent in an aqueous solution, the amount of the organic solvent is 2.5 parts by weight or less, when the amount of the template component is 1 part by weight.

When the weight ratio of an organic solvent exceeds 2.5, too much organic solvent penetrates into the mold formed by the template component, and the pore shape is hard to maintain. Therefore, the weight ratio of the organic solvent is preferably 2.5 or less.

In the method of producing the mesoporous body, a conventional heat treatment can be employed as a treatment to obtain a precipitate, however, pressure and heat are preferably applied to the aqueous solution.

In the case of obtaining a precipitate from the aqueous solution, penetration of an organic solvent into the mold formed by the template component is improved by raising the temperature because the viscosity of the aqueous solution is thus decreased. However, at the same time, water in the aqueous solution is easily vaporized. Therefore, vaporization of water can be preferably suppressed by a pressure treatment.

In order to apply pressure and heat to an aqueous solution, the method of subjecting the aqueous solution to a hydrothermal synthesis, irradiation with supersonic waves or irradiation with microwaves can be employed.

### BRIEF DESCRIPTION OF THE DRAWINGS

FIG. 1 is a schematic perspective view showing a mesoporous body according to an embodiment of the present invention.

FIG. 2(a) is a process drawing showing a method of the above embodiment.

FIG. 2(b) is a process drawing showing a conventional common method.

### DETAILED DESCRIPTION

Embodiments of the present invention will now be described with reference to the accompanying drawings.

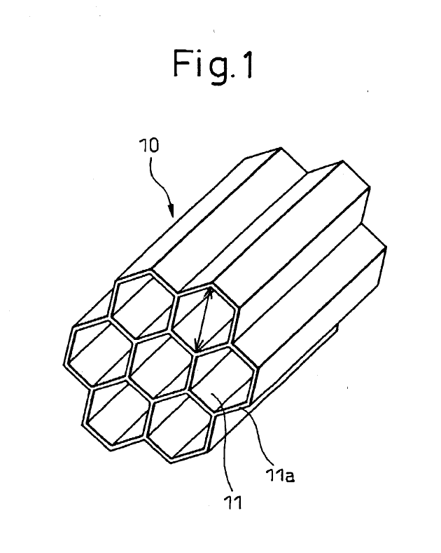

FIG. 1 is a perspective view showing the schematic configuration of a mesoporous body (10) according to the embodiment of the present invention.

The mesoporous body (10) of the present embodiment has pores partitioned by a pore wall (11a), wherein the pores have a diameter of 5 nm or more and less than 50 nm. The mesoporous body (10) of this example has a pore size of 8 nm or more and 20 nm or less, and pores (11) having the same size are regularly aligned uniformly throughout the entire region of the mesoporous body (10).

FIG. 1 shows the mesoporous body with a hexagonal structure. The pores (11) have a hexagonal shape and the pore size corresponds to the distance between facing angles as shown in FIG. 1. The shape of the pores (11) is not limited thereto, but may be the other shapes such as a circular or quadrangular shape.

The mesoporous body (10) is composed of a metal oxide. The metal constituting the metal oxide is a single metal selected from Ce, Zr, Al, Ti, Si, Mg, W, Fe, Sr, Y, Nb and P, or a solid solution of two or more kinds of these metals. In this example, the mesoporous body (10) is composed of silica. The size of the mesoporous body (10) is 1.0 μm or less.

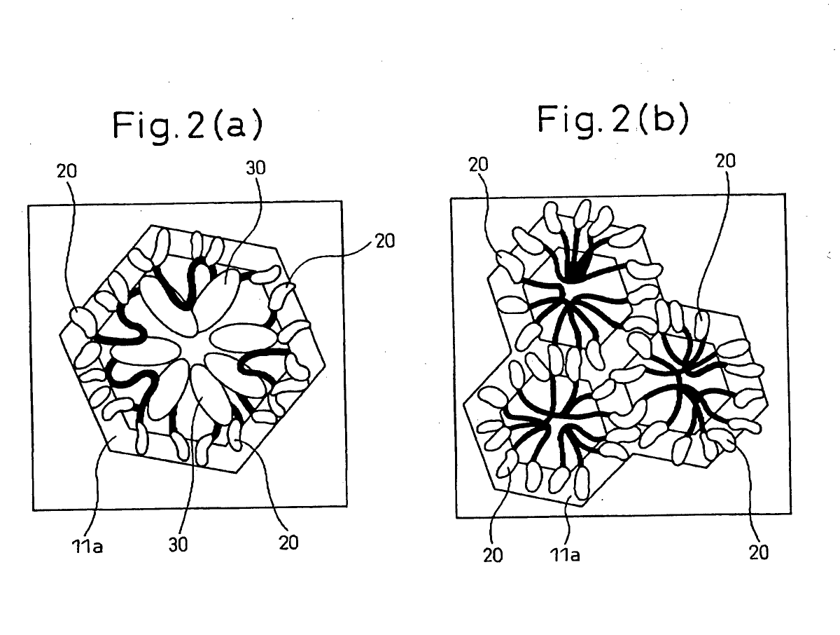

The method of producing the mesoporous body (10) will now be described with reference to FIGS. 2(a) and 2(b). FIG. 2(a) is a process diagram showing the method of the invention, while FIG. 2(b) is a process diagram showing a conventional method. This method is an application of a conventional template method of forming a mesoporous body using a template as a mold.

First, an aqueous solution containing a template component (20) serving as a mold for pores (11) of a mesoporous body (10) is prepared. Then, an aqueous solution containing, in addition to a template component (20), an organic solvent (30) having an affinity for the template component (20) is prepared.

Specifically, an acidic aqueous solution (with, for example, pH of approximately 1) is prepared by mixing a template component (20) with an organic solvent (30). As the template component (20), a commonly used amphipathic poly(alkylene oxide) block copolymer can be used, and its molecular weight should be 1,000 or more.

Specifically, a block copolymer selected from a triblock copolymer, wherein a hydrophilic polyalkylene oxide is bound covalently to each of facing terminals of a hydrophobic polyalkylene oxide, and a diblock copolymer, wherein a hydrophobic polyalkylene oxide is bound covalently to a terminal of a hydrophilic polyalkylene oxide, can be employed.

As a hydrophilic polyalkylene oxide, polyethylene oxide is used and, as a hydrophobic polyalkylene oxide, those selected from polypropylene oxide, polybutylene oxide, polyphenylene oxide and a polyhydroxy acid can be employed. Glycol acid, lactic acid, malic acid, tartaric acid or citric acid is effectively used as the polyhydroxy acid.

More specifically, a triblock copolymer (EOx-POx-EOx), wherein a hydrophilic poly(alkylene oxide) such as poly (ethylene oxide) (EOx) is bound covalently to each of the facing terminals of a hydrophobic poly (alkylene oxides) such as polypropylene oxides (POx), is exemplified, wherein x and y represent the polymerization degrees of respective polymers. In the case of EO20-PO70-EO20, for example, the polymerization degree of EO is 20 and that of PO is 70.

The hydrophilic polyalkylene oxide has the function of dissolving the block copolymer in the aqueous solution, and the function of reacting the raw material forming a mesoporous body to form the frame of the mesoporous body, while the hydrophobic polyalkylene oxide functions as a mold for a mesoporous body.

Accordingly, integration of the polyalkylene oxides is essential for formation of a mesoporous body. However, the content of the hydrophilic polyalkylene oxide is preferably 30% or more and 60% or less so that it dissolves in the aqueous solution.

The organic solvent (30) includes two types, for example, a first organic solvent which plays a role of increasing pores by solubilizing into the center of the mold; and a second solvent which exists in the vicinity of a framework of the mesoporous body (10), thereby reinforcing the framework.

The first organic solvent (30) is not specifically limited, as long as it has an affinity for a hydrophobic moiety of the template component (20). However, at least one or more solvents selected from cyclic ethers, glycol diethers, benzenes, esters, ketones and alkanes can be employed. More specifically, THF, diglyme, monoglyme, trioxane, tripropylbenzene, acetone, hexane, cyclohexane, octane, dioxane and the like are exemplified.

The second organic solvent (30) is not specifically limited, as long as it has an affinity for a hydrophilic moiety of the template component (20). However, at least one or more solvents selected from alkylene oxides, alcohols, carboxylic acids and esters can be employed. More specifically, polyethylene oxide, polyvinyl alcohol, propanol, butanol, polyacrylic acid, oleic acid and the like are exemplified.

Dioxane, acetone and the like have an affinity for the hydrophilic moiety as well as the hydrophobic moiety. Therefore, they can also play both of a role of an agent capable of increasing the pore size and a role of forming the framework of the mesoporous body. In other words, a single organic solvent (30) can have both functions of the first and second organic solvents.

In the triblock copolymer as the template component (20), the first organic solvent (30) has an affinity for a hydrophobic poly(alkylene oxide) such as poly(propylene oxide) (POx), while the second organic solvent (30) has an affinity for a hydrophilic poly(alkylene oxide) such as poly(ethylene oxide) (EOx).

The affinity of the organic solvent (30) used in this embodiment is higher than that of trimethylbenzene described in Japanese Unexamined Patent Publication No. 2003-531083. An organic solvent such as cyclohexane, hexane, tripropylbenzene, octane or the like, has a bulkier structure than that of trimethylbenzene and can increase the pore size with a steric hindrance effect.

Regarding the weight ratio of the template component (20) to the organic solvent (30) in the aqueous solution, the amount of the organic solvent is 2.5 parts by weight or less, when the amount of the template component is 1 part by weight, so as to prevent the pores (11) from breaking easily when the pore size is too large. More preferably, the amount of the organic solvent (30) is 1 part by weight or less, when that of the template component is 1 part by weight. Since the first and second solvents exert a separate function from each other, a mixture of the first and second solvents can desirably form a more stable mesoporous body.

Thus, the template component (20) and the organic solvent (30) are mixed and stirred at room temperature for 10 hours or longer. Consequently, an aqueous solution containing, in addition to the template component, the organic solvent having an affinity for the hydrophobic moiety of the template component is prepared.

The raw material of the mesoporous body (10) is then dissolved in the aqueous solution to obtain a precipitate. Specifically, the material component of the mesoporous body (10) such as tetraethyl orthosilicate (TEOS) is dissolved, and is then heated to obtain a precipitate.

In this embodiment, as shown in rig. 2(a), a raw material component penetrates so as to surround the periphery of the template component (20) by hydrolysis of the raw material of the mesoporous body (10), when the precipitate is formed.

Although not shown in FIG. 2(a), the hydrophobic first organic solvent (30) exists at the center of a structured body formed by the template component (20), while the hydrophilic second organic solvent (30) exists at the periphery. Accordingly, in the system containing the second organic solvent (30), the raw material component penetrates so as to surround the periphery of the template component (20) and the second organic solvent (30) by hydrolysis of the raw material of the mesoporous body (10).

At the same time, the template component (20) in the aqueous solution is self-organizing to form a mold for pores (11), and pore walls (11a) constituting pores (11) are formed around the template component (20) and the second organic solvent (30). Thus, the precipitate is produced.

Since the organic solvent (30) having an affinity for the hydrophobic moiety of the template component (20) is contained in the aqueous solution, the organic solvent (30) easily penetrates into the self-organized structure of the template component (20) and increases the pore size.

In a conventional common template method in which no organic solvent is added, the mold can be formed of the template component (20), as shown in FIG. 2(b), but the pore size does not increase as a result of impregnation of the organic solvent (30) in this embodiment. In addition, the second organic solvent (30) has the effect of slightly increasing the thickness of the pore wall and improving the regularity of the pore wall, and thus a more stable mesoporous body can be formed.

Although a conventional heat treatment can be conducted as a treatment to obtain the precipitate, pressure and heat are preferably applied to the aqueous solution. As shown in FIG. 2(a), when the precipitate is obtained from the aqueous solution, the viscosity of the aqueous solution is decreased when heated to high temperature. As a result, penetration of the first and second organic solvents (30) into the mold formed by the template component (20) is improved and also water in the aqueous solution is easily vaporized.

Therefore, when subjected to a pressure treatment, in addition to a heat treatment, vapor pressure increases and the vaporization of water can be controlled. In order to apply pressure and heat to the aqueous solution, a method of subjecting the aqueous solution to a hydrothermal synthesis treatment, irradiation with supersonic waves or irradiation with microwaves can be employed.

In hydrothermal synthesis, for example, an aqueous solution is charged in a heat resistant vessel and heated to 120° C. In irradiation with supersonic waves, an aqueous solution is irradiated with supersonic waves using a common supersonic generator, and bubbles thus generated are burst and impact energy produced therefrom locally forms a high-pressure state in the aqueous solution.

In irradiation with microwaves, a commercially available microwave generator is used and an aqueous solution is irradiated with the same microwaves as that generated by a common microwave oven, and impact thus produced is applied to locally form a high-temperature and high-pressure state. Thus, it is presumed that a pressure and heat treatment enables formation of a mold as a precursor obtained by integrating the template component (20) and the first and second organic solvents (30) in the aqueous solution, as shown in FIG. 2(a).

The precipitate obtained from the aqueous solution is separated, dried and fired. Consequently, the template component (20) and the first and second organic solvents (30) in the precipitate are burnt. The spaces resulting from the burning of the template component (20) turn into pores (11) and the mesoporous body (10) is produced.

As described above, according to the method of the present embodiment, in a step of preparing an aqueous solution containing a template component (20) serving as a mold of pores (11) of a mesoporous body (10), a solution containing, in addition to the template component (20), a first organic solvent (30) having an affinity for a hydrophobic moiety of the template component (20) and a second organic solvent (30) having an affinity for a hydrophilic moiety of the template component (20) is prepared as the aqueous solution.

Consequently, when a precipitate is formed, the organic solvents (30) easily penetrate into a self-organized structure of the template component (20), and a pore size is increased. Therefore, a mesoporous body (10) having efficiently increased pores (11) can be prepared without destroying the regularly aligned structure of pores (11). In addition, mixing with the second organic solvent (30) enables a slight increase in thickness of a pore wall and improvement of regularity of the pore wall, thus making it possible to produce a more stable mesoporous body.

In the above method, by adjusting the kind and the amount of the first and second organic solvents (30) to be added, the pore size of the mesoporous body (10) can be uniformly controlled within the range from 8 nm or more to 20 nm or less throughout the entire region of the mesoporous body (10).

### EXAMPLES

An example of controlling the pore size of the mesoporous body in a given diameter within a range of 8 nm or more and 20 nm or less in the method of the present embodiment will now be described in more detail with reference to the respective Examples and Comparative Examples. However, the present invention is not restricted to the following Examples.

### Example 1

In this example, EO20-PO70-EO20 was used as a template component, and acetone was used as an organic solvent because acetone has both of hydrophobicity and hydrophilicity, in other words, both functions of the first and second organic solvents.

Hydrochloric acid was added to pure water to adjust the pH to 1 or less. EO20-PO70-EO20 was added to pure water with pH of 1 or less and acetone was added with stirring to prepare an aqueous mixed solution of a template component and acetone. The weight ratio of water, EO20-PO70-EO20 and acetone was 120:4:4.

After fully stirring the aqueous solution, tetraethyl orthosilicate (TEOS) was added in a weight ratio 2:1 of TEOS to the template component, and the resulting aqueous solution was stirred at a room temperature for 10 hours or more. Then, the aqueous solution was transferred into a pressure resistant vessel and a hydrothermal synthetic treatment was carried out at 120° C. for 24 hours to obtain a precipitate.

The precipitate was taken out from the pressure resistant vessel, dried and fired at 600° C. to burn down the template component and TEOS to obtain a mesoporous body consisting of silica.

### Example 2

In the same manner as in Example 1, except that a hydrophilic propanol was used as the organic solvent, a mesoporous body consisting of silica was prepared.

### Example 3

In the same manner as in Example 1, except that a hydrophilic butanol was used as the organic solvent, a mesoporous body consisting of silica was prepared.

### Example 4

In the same manner as in Example 1, except that a hydrophobic dicyclohexane was used as the organic solvent, a mesoporous body consisting of silica was prepared.

### Example 5

In the same manner as in Example 1, except that a hydrophobic hexane was used as the organic solvent, a mesoporous body consisting of silica was prepared.

### Example 6

In the same manner as in Example 1, except that a hydrophobic tripropylbenzene was used as the organic solvent, a mesoporous body consisting of silica was prepared.

### Example 7

In the same manner as in Example 1, except that a hydrophobic octane was used as the organic solvent, a mesoporous body consisting of silica was prepared.

### Example 8

In the same manner as in Example 1, except that the weight ratio of water, EO20-PO70-EO20 and tripropylbenzene was adjusted to 120:4:1, a mesoporous body consisting of silica was prepared.

### Example 9

In the same manner as in Example 1, except that the weight ratio of water, EO20-PO70-EO20 and tripropylbenzene was adjusted to 120:4:2, a mesoporous body consisting of silica was prepared.

### Example 10

In the same manner as in Example 1, except that EO20-BO(butylenes oxide)70-EO20 was used as the template component, a mesoporous body consisting of silica was prepared.

### Example 11

In the same manner as in Example 1, except that a hydrophobic tripropylbenzene and a hydrophilic oleic acid were used as the organic solvent, a mesoporous body consisting of silica was prepared.

### Comparative Example 1

In the same manner as in Example 1, except that no organic solvent was added, a mesoporous body consisting of silica was prepared.

### Comparative Example 1

In the same manner as in Example 1, except that trimethylbenzene was used as the organic solvent, a mesoporous body consisting of silica was prepared.

In order to confirm the pore sizes of the mesoporous bodies prepared in Examples 1 to 9 and Comparative Examples 1 and 2, the pore size distributions thereof were measured by Transmission Electron Microscope (TEM) observation. In each of Examples 1 to 9, the regularly aligned structure of pores was maintained, and the pore size was uniform throughout the entire region.

The pore sizes of the mesoporous bodies prepared in Examples 1 to 7 and Comparative Examples 1 and 2 are shown in Table 1.

TABLE 1

| | Organic solvent | Pore size (nm) |
|---|---|---|
| Example 1 | acetone | 9 |
| Example 2 | propanol | 9 |
| Example 3 | butanol | 9.8 |
| Example 4 | cyclohexane | 12.4 |
| Example 5 | hexane | 16.1 |
| Example 6 | tripropylbenzene | 16.1 |
| Example 7 | octane | 19.2 |
| Comparative Example 1 | none | 6.8 |
| Comparative Example 2 | trimethylbenzene | 7 |

As shown in Table 1, Comparative Example 1 wherein no organic solvent was added, and Comparative Example 2 wherein a conventional trimethylbenzene was used as the organic solvent, the resulting mesoporous bodies had a pore size of less than 8 nm.

The pore size of the mesoporous body prepared in Example 10 was 11.2 nm, and that of the mesoporous body prepared in Example 11 was 16.5. In Example 10, it is considered that the pore size could be increased, since the hydrophobic moiety of the template component was larger than that in Example 1. In Example 11, since the mixture of a hydrophobic organic solvent (first organic solvent) capable of enlarging the pore size and a hydrophilic organic solvent (second organic solvent) capable of forming the pore wall was used, it is considered that a more stable structure could be formed.

According to TEM observation, in Comparative Example 2 wherein trimethylbenzene was used, the pore size could partially be increased to 8 nm or more, but was failed to be increased uniformly throughout the entire region of the mesoporous body. In addition, some problems, including destruction of the regularly aligned structure of the pores, arose.

On the other hand, in Examples 1 to 11 wherein the organic solvents of the present embodiment were used, pores having a pore sizes of 8 nm or more could be formed uniformly throughout the entire region of the mesoporous bodies, and the regularly aligned structure could be also secured.

As shown in Table 1, the pore size can be controlled to any given size between 8 nm or more and 20 nm or less, by selecting the kind of an organic solvent to be added. It is considered that the pore size varies depending on ease of the penetration and the molecular size of the organic solvent.

The pore sizes of the mesoporous bodies prepared in Examples 6, 8 and 9 and Comparative Examples 1 are shown in Table 2.

TABLE 2

| | Ratio of added organic | |
|---|---|---|
| | solvent [water:EO20-PO70- | |
| | EO20:tripropylbenzene] | Pore size (nm) |
| Comparative | 120:4:0 | 6.8 |
| Example 1 | | |
| Example 8 | 120:4:1 | 13.1 |
| Example 9 | 120:4:2 | 15.2 |
| Example 6 | 120:4:4 | 16.1 |

That is, Table 2 shows the effects of varying the weight ratio of tripropylbenzene as the organic solvent of the present embodiment.

As shown in Table 2, as the amount of the organic solvent to be added to the aqueous solution increases, the pore size of the mesoporous body can be increased uniformly throughout the entire region of the mesoporous body.

In other words, by selecting the amount of the organic solvent, the pore size of the mesoporous body can be controlled. As described above, for the weight ratio of the template component to the organic solvent in the aqueous solution, when the amount of the template component is 1 part by weight, the amount of the organic solvent is preferably 2.5 parts by weight or less, more preferably 1 part by weight or less, because too much organic solvent has an adverse effect on maintaining the shape of pores.

In order to confirm the hydrothermal durability performance of the mesoporous bodys prepared in the respective Examples, the following test was carried out. The resulting mesoporous body was molded into pellets and then placed in a tubular furnace. The atmosphere in the furnace was substituted by steam at 900° C. and the durability test was carried out for 5 hours. Then, the pellet-shaped mesoporous body was ground and TEM observation was carried out.

After the test, the same pore shape as that before the hydrothermal durability test was confirmed in the respective Examples above. That is, it was found that the mesoporous bodys in the respective Examples could maintain the original pore shape even after being exposed in the steam atmosphere at 900° C. It was also found that the thickness of the pore wall was 3 nm or more in the respective Examples.

According to the above method, the thickness of the pore wall can be controlled by adjusting the conditions of hydrothermal synthesis (temperature, time), irradiation with supersonic wave and irradiation with microwave, and a three-dimensional structure of a mesoporous body can be maintained up to 900° C. by adjusting the thickness of the pore wall to 3 nm or more.

In order to adjust the thickness of the pore wall to 3 nm or more, the polymerization degree of the hydrophilic moiety as in poly(ethylene oxide) (EOx) is preferably adjusted to 20 or more when the template component is selected.

### Other Embodiments

When a precursor obtained by integrating a template component and an organic solvent is transferred into a raw material of a mesoporous body, hydrolysis of metal alkoxides such as the TEOS as the raw material of the mesoporous body is applied. Therefore, when the pore wall of silica is formed, the atmosphere of high pressure and high temperature can be applied as it exerts an intensive hydrolytic action. As the means for building the atmosphere, as described above, hydrothermal synthesis, supersonic waves and microwaves can be applied.

While a common amphipathic poly(alkylene oxide) block copolymer such as a triblock copolymer (EOx-POx-EOx) was described as the template component, the block copolymer is not limited thereto as long as it can be employed in a conventional template method.

1. A method for producing a mesoporous body, which comprises preparing an aqueous solution containing a template component serving as a mold of pores of the mesoporous body, dissolving a raw material of the mesoporous body in the aqueous solution to obtain a precipitate, and then drying and firing the precipitate, wherein
the aqueous solution to be used containing, in addition to the template component, an organic solvent having an affinity for the template component.

2. The method for producing a mesoporous body according to claim 1, wherein an amphipathic poly(alkylene oxide) block copolymer is used as the template component.

3. The method for producing a mesoporous body according to claim 2, wherein the molecular weight of the poly(alkylene oxide) block copolymer is 1,000 or more.

4. The method for producing a mesoporous body according to claim 2, wherein the content of hydrophilic polyalkylene oxide in the poly(alkylene oxide) block copolymer is 30% or more and 60% or less.

5. The method for producing a mesoporous body according to claim 1, wherein the block copolymer comprises one or more block copolymers selected from triblock copolymers, wherein a hydrophilic polyalkylene oxide is bound covalently to each of facing terminals of a hydrophobic polyalkylene oxide, and diblock copolymers, wherein a hydrophobic polyalkylene oxide is bound covalently to a terminal of a hydrophilic polyalkylene oxide.

6. The method for producing a mesoporous body according to claim 5, wherein the hydrophilic polyalkylene oxide is polyethylene oxide.

7. The method for producing a mesoporous body according to claim 5, wherein the hydrophobic polyalkylene oxide is one selected from polypropylene oxide, polybutylene oxide, polyphenylene oxide and a polyhydroxy acid.

8. The method for producing a mesoporous body according to claim 7, wherein the hydrophobic polyalkylene oxide is a polyhydroxy acid, and the polyhydroxy acid is one selected from glycolic acid, lactic acid, malic acid, tartaric acid and citric acid.

9. The method for producing a mesoporous body according to claim 1, wherein the organic solvent having an affinity for the template component has solubility in a hydrophobic polyalkylene oxide.

10. The method for producing a mesoporous body according to claim 9, wherein the organic solvent having solubility to the hydrophobic polyalkylene oxide comprises one or more solvents selected from cyclic ethers, glycol diethers, benzenes, esters, ketones and alkanes.

11. The method for producing a mesoporous body according to claim 1, wherein the organic solvent having an affinity for the template component has solubility in a hydrophilic polyalkylene oxide.

12. The method for producing a mesoporous body according to claim 11, wherein the organic solvent having solubility to the hydrophilic polyalkylene oxide comprises one or more solvents selected from alkylene oxides, alcohols, carboxylic acids and esters.

13. The method for producing a mesoporous body according to claim 1, wherein the weight ratio of the template component to the organic solvent in the aqueous solution is 1 to 2.5 or less.

14. A method for producing a mesoporous body according to claim 1, wherein pressure and heat are applied to the aqueous solution, as a procedure to obtain the precipitate.

15. The method for producing a mesoporous body according to claim 14, wherein the application of pressure and heat to the aqueous solution is achieved by subjecting the aqueous solution to a hydrothermal synthetic treatment, irradiation with supersonic waves or irradiation with microwaves.
